(19) United States
(12) Patent Application Publication
(10) Pub. No.: US 2011/0308160 A1
(43) Pub. Date: Dec. 22, 2011

(54) DOOR SAFETY GATE

(76) Inventor: Sebastien BOUCQUEY, Brussels (BE)

(21) Appl. No.: 13/163,375

(22) Filed: Jun. 17, 2011

Related U.S. Application Data
(63) Continuation of application No. PCT/EP2009/008033, filed on Nov. 11, 2009.

(30) Foreign Application Priority Data
Dec. 18, 2008 (DE) DE 102008062774.7

(51) Int. Cl. E06B 5/00

(52) U.S. Cl. 49/50

(57) ABSTRACT

A door safety gate is provided with an essentially flat first grid that has a handle (9) at an upper crossbar. The handle being pivotable about a pivot axis and the handle being drivingly connectable with a first slide, in particular a plastic buffer. A longitudinal axis of the first slide extends substantially parallel to a longitudinal axis of the upper crossbar, whereby the longitudinal axis of the upper crossbar lies in a plane of the door safety gate and whereby the handle is a part of a toggle mechanism, whereby the handle has a locking slide, and whereby the handle is secured against releasing in an end position of the locking slide.

This nonprovisional application is a continuation of International Application No. PCT/EP2009/008033, which was filed on Nov. 11, 2009, and which claims priority to German Patent Application No. DE 10 2008 062 774.7, which was filed in Germany on Dec. 18, 2008, and which are both herein incorporated by reference.

### BACKGROUND OF THE INVENTION

1. Field of the Invention

The present invention relates to a door safety gate.

2. Description of the Background Art

Typically, door safety gates are clamped into a frame at doors and stairs to protect children.

Conventional safety gates comprises several door safety gates, which are commercially available. Such door safety gates mostly include a grid, a clamping device and a force transmission component.

The grids mostly provide a planar rectangular face. This rectangular face is terminated in its height by an upper and a lower crossbar. Lathes are extending perpendicular to the crossbars, which fill the grid's area with a given spacing. Often, longitudinal bars are further provided at the beginning and end sections, perpendicular to the crossbars and parallel to the lathes, the cross section of the longitudinal bars providing a bigger resistance torque against bending than the cross sections of the lathes.

In a frame, these door safety gates are held by pressing forces. The pressing forces are generated by the clamping device and transmitted onto the frame by one or more plastic buffers. The transmission of the pressing forces from the clamping device to the plastic buffer is performed by a mechanical component, such as slides.

Thereby, the clamping device has a U-shaped handle on the upper crossbar which partially surrounds the upper crossbar and which can be pivoted about a pivot axis, the pivot axis extending perpendicular to a plane of the door handle, wherein the handle is drivingly connected to a plastic buffer, the plastic buffer being longitudinally moveably supported in the upper crossbar, wherein the handle has a locking slide that is preloaded in a first end position, the handle being secured against an unintended movement in the first position.

In case the handle's position is changed by the pivoting movement, the position of the plastic buffer is also changed. Dependent on the position of the plastic buffer with respect to the frame, the door safety gate is being secured or unsecured. In the case of a secured handle position, the door safety gate is firmly clamped in the frame.

The conventional art also includes door safety gates which are furthermore positively connected to a toggle mechanism. By means of the toggle mechanism the position of a second plastic buffer is changed simultaneously with the first plastic buffer, the second plastic buffer being located in the lower crossbar. For example, such door safety gate is described in the patent document U.S. Pat. No. 2,928,146.

For many door gates, a handle securing device is designed such that the force, which presses the plastic buffer onto the wall and thereby holds the door safety gate in the frame, can be terminated by pressing a release button followed by pivoting about the pivot axis.

Thereby, primary demand of the handle securing device is that it cannot be released, or can only very difficultly be released, by children.

Handle securing devices which—by adults—can be released single-handed, frequently are unsecured by a series of movements which can be easily detected and realized—by means of trial—by children. This securing has then lost its determination.

### SUMMARY OF THE INVENTION

It is therefore an object of the present invention to provide a door securing device, wherein an unsecuring of the handle is significantly more difficult for children.

The solution according to the invention provides a locking slide which can be shifted in the longitudinal direction of the handle parallel to the plane of the door safety gate from the preloaded first end position to a second end position, into which the handle can be pivoted.

A precondition for an unlocking of the handle and thereby a release of the door safety gate is a shifting of the locking slide from the first end position against a spring force. Subsequently, a pivoting of the handle about its pivot axis in the plane of the grid is necessary. Thereby, the plastic buffer is pulled back from its abutting position. The grid has no more hold in the door frame. Thereby the locking slide is arranged and moveable on the handle in such way that a movement of the locking slide and a subsequent pivoting of the handle can be performed with just a single hand.

The European norm demands for safety reasons, that a gate can be open only by a double movement, or, if just a single movement is necessary, there has to be a force of 50 Newton in order to open it. Therefore, the present door safety gate has a locking slide and a handle which needs to be pivoted for the opening of the grid.

The locking slide can have a web at an inner side, it being possible that a support which has a tenon and a spring holder is plugged on the web. This kind of design allows for a quick and precise assembly of the support without tools. The support is made from single piece, which allows for a cost effective production.

A particularly fast clamping in the door frame is made possible in case the gate has a lower crossbar, a second plastic buffer being supported in the second crossbar parallel to the first plastic buffer, wherein the handle drives the second plastic buffer synchronously with the first plastic buffer by means of a link mechanism, the link mechanism preferably includes a vertically moveable lath and a second toggle mechanism.

The handle can have an inner space with two side faces and an upper side and a longitudinal slit, wherein the longitudinal slit perforates the upper side.

The web of the locking slide can be inserted through the longitudinal slit for the assembly. In this case the locking slide rests on the rear face of the handle with its u-shaped cross section. It partially encloses the handle and abuts on its side faces. The halves of the handle are fixedly held by a screw. By way of the enclosing, the locking slide keeps the handle integral even if the screw has loosened.

The handle can have two handle halves which can be put together along a separation running through a central axis of the upper side.

The design of the handle allows for a quick and positive assembly of the handle halves.

The handle can have two holes at one end which oppose each other symmetrically and are located in a side face in each case.

These holes are part of a bearing through which the pivot axis is extending. The bearing is mounted at the upper crossbar. It is fixed by means of a positive connection.

At the outsides of its side faces, the handle can have guides for guiding the locking slide, the locking slide being moveable on the guides with its side guides.

The guiding of the locking slide on the handle ensures a stable position of the locking slide during the movement and in a resting position.

The web of the locking slide can be inserted into the inner of the handle through the longitudinal slit.

This construction allows for a quick and positive assembly, as the locking slide can be placed on the handle in just one orientation because of its form and the form of the handle.

The handle can have a stop at its upper side.

By way of this design the outlay of the surface support the operation of the locking slide, as the locking slide can be moved in one direction only starting from its first end position. The locking slide abuts to the stop when located in its first end position.

The longitudinal slit has a straight boundary on its one end, the straight boundary extending perpendicular to a central axis of the handle.

The longitudinal slit provides a limitation for the position of the locking slide because the web of the locking slide is inserted into the inner of the handle through the longitudinal slit.

The displacement of the locking slide is limited by the straight boundary.

During operation, the spring holder incorporates a spring which is pressed against the straight boundary if the locking slide is moved away from the stop. In this way a spring force is built up, by means of which the locking slide is preloaded in a first end position. Substantially simultaneously, the tenon is pressed under a protrusion in such way that a pivoting of the handle about the pivot axis becomes impossible. The handle is secured and the door securing remains in its position.

The web can have two cylindrical sockets of different height. The support is plugged onto these sockets. The different height of the sockets provides for a positive orientation of the support on the socket. Hence a faulty assembly and possible malfunction is prevented.

The cylindrical sockets can be arranged symmetrically with respect to a central axis of the locking slide and have a female thread in each case.

The symmetric arrangement of the cylindrical sockets allows for the symmetric design of the handle with the symmetrically arranged longitudinal slit. This simplifies the production of these parts as no asymmetric part needs to be produced. The threads in the sockets enable a screwing of the plugged-on support with the web. The support has also holes which are aligned with holes of the socket in order to allow for a positive connection.

The locking slide has a recess on its inner side symmetrically to the central axis, the recess having a cross section in the form of a circular arc and beginning in front of the web and ending at the straight boundary.

The spring can be inserted into the recess parallel to a central axis. Prior to this, the spring has yet been put over the spring holder. The spring which is sited on the spring holder is placed on the circular arc-shaped recess immediately before the support is plugged onto the sockets. By means of a correct plugging of the support onto the web, the correct arrangement of the spring-equipped spring holder in the circular arc-shaped recess then results automatically.

The support can be moveable on the guide rails.

The handle has two guide rails. They are located parallel to each other in the inner space of the handle, which is comprising two handle halves. The guide rails are of even size and of a rectangular shape in each case. If the support is moved, it is sliding over the guide rails.

A support face of the tenon reaches under a holding face of the protrusion, wherein the tenon is moveable against the protrusion. In this case, the support face of the tenon encompasses the protrusion. The support face of the tenon is thereby pressed against the holding face of the protrusion. The tenon is thereby moveable as far against the protrusion until a column, into which the tenon is integrated, abuts to the protrusion. The locking slide then has reached its first end position.

In case a handle which is moved from the first end position and pivoted about the pivot axis is locked, the locking slide is moved automatically against the spring by via a bevel of the tenon.

In an embodiment of a door safety gate according to the invention, it is provided that the door safety gate can be pivotably articulated to a frame via a swivel. Thereby the door safety gate can be provided as a hinged door, which can be fixed in a closed position via the same closing mechanism like in the case of a design variant which can be entirely removed from the frame.

The possibility of removal of the door safety gate can, according to the respective demands, also be provided in the case of an embodiment which is pivotably articulated if the swivel joints are accordingly designed to be detachable.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a side view of a locked door safety gate.

FIG. 2 shows a side view of one half of a handle.

FIG. 3 shows a plan view on the half of the handle.

FIG. 4 shows an inner view of a handle.

FIG. 5 shows a partial sectional plan view on the handle.

FIG. 6 shows a sectional side view of locked handle.

FIG. 7 shows a locked door safety gate with a toggle mechanism at the upper crossbar.

FIG. 8 shows a longitudinal sectional view through a locking slide.

FIG. 9 shows a view of a locking slide from below.

FIG. 10 shows a side view of a support.

FIG. 11 shows a plan view on the support.

FIG. 12 shows a view of the support from below.

FIG. 13 shows a sectional side view of the locked handle which is connected to a lath.

FIG. 14 shows a detail view of FIG. 13, displaying the position of a bevel.

FIG. 15 shows the position and the design of the protrusion 43.

FIG. 16 shows a pivotably articulated variant of the embodiment of FIG. 1.

### DETAILED DESCRIPTION

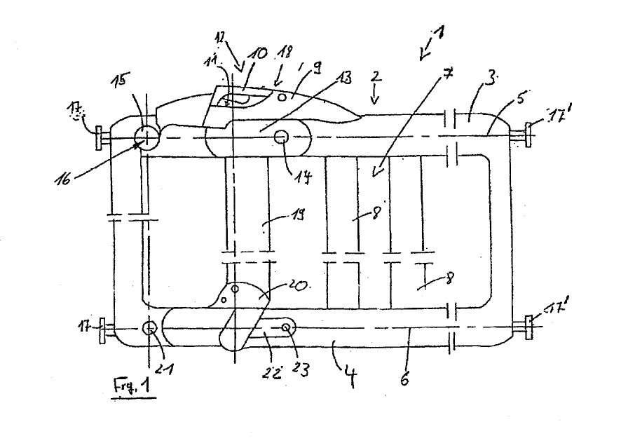

The door safety gate 1 in FIG. 1 includes a flat grid 2 with a rectangular shape. The grid 2 has an upper crossbar 3 and a lower crossbar 4. The lower crossbar 4 extends parallel to the upper crossbar 3. The grid is terminated in its height by the crossbars 3 and 4. The upper and lower crossbar 3, 4 have a respective longitudinal axis. The grid 2 has a grid plane 7 which is filled with lathes 8. The lathes 8 have a roughly equal spacing. They extend perpendicular to the longitudinal axes 5, 6 and are embraced in the upper and lower crossbar 3, 4.

The upper crossbar 3 has a handle 9 with a U-shaped cross section. The handle 9 has a locking slide 10 which can be shifted along a guide 11 over a rear face 12 of the handle 9. The handle 9 is linked to a toggle mechanism 13. The toggle mechanism 13 is pivotably supported on an axis 14 in the upper crossbar 3. The axis 14 extends perpendicular to the longitudinal axis 5 of the upper crossbar 3 and to the plane of the grid 2. The handle 9 further has a pivot axis 15, which also is oriented perpendicular to the longitudinal axis 5 of the upper crossbar 3. The handle 9 is, after being unlocked, pivotable about the axis 15. The handle 9 is connected with a movable plastic buffer 17 by means of a mechanical connection. At the far end of the crossbars 3, 4, fixed plastic buffers 17′ are provided.

In the position on display, the locking slide 10 is a first end position at a stop 18 of the handle 9.

In case the locking slide 10 is shifted parallel to the guide 11 in the direction of the pivot axis 15 against a resistance, and subsequently the handle 9 is pivoted about the pivot axis 15, the plastic buffer 17 is being retracted.

In this way, the door safety gate 1 is releasable from a frame which belongs to a door or a stair access. The door safety gate has a total of four plastic buffers 17, 17′.

The upper and lower crossbar 3, 4 have two plastic buffers 17, 17′ respectively. In each case, they are arranged coaxially to the longitudinal axes 5, 6 of the upper and the lower crossbar 3, 4. The movable plastic buffer 17 has the task of clamping the door safety gate in the frame by transferring the clamping force which is generated by locking of the handle 9. After the locking, the handle 9 sits upon the upper crossbar 3.

In the case of an axial load on the plastic buffer 17 in the direction of the longitudinal axis 5, the toggle mechanism 13 pulls the handle 9 in the direction of the grid 2. It thereby has a protection function and snapping open or releasing of the Handle is made impossible or hindered in this situation. The toggle mechanism 13 is pivotably supported at the upper crossbar 3 in a bearing 16. The bearing 16 is assembled in the pivot axis 15, perpendicular to the longitudinal axis 5 of the upper crossbar 3.

In the drawing, the handle 9 is releasably connected to a lath 19. The lath 19 is connected with a plastic buffer 17 via a hinge 20, which is supported rotatably in an axis 21. The connection between the plastic buffer 17 and the hinge 20 is provided in the way of a link mechanism. The axis 21 thereby extends perpendicular to the longitudinal axis of the lower crossbar 4.

The hinge 20 is pivotably connected to a second toggle mechanism 22, which is supported in the lower crossbar 4 in an axis 23. The axis 23 extends perpendicular to the longitudinal axis 6 of the lower crossbar 4 and to the plane of the grid 2.

Alternatively to the present description, the door safety gate 1 can be used without the hinge 20. In this embodiment, just one plastic buffer 17 transfers the clamping force onto the wall.

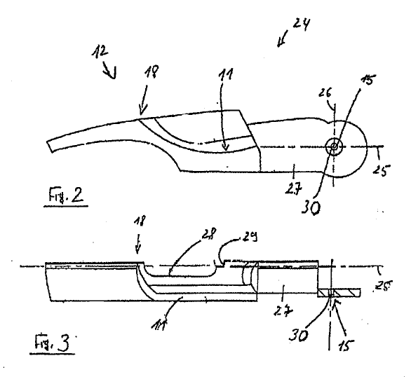

In FIG. 2, a handle half 24 of the handle 9 is displayed in a side view. Essential components of the handle half 24 are a horizontal center axis 25, the rear face 12 with the stop 18 and the guide 11. The locking slide 10 is moveable on the guide 11.

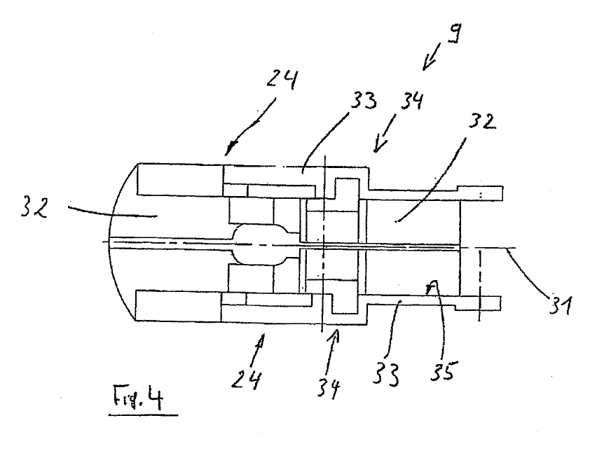

A plan view of the handle half 24 is shown in FIG. 3. The handle half 24 has a longitudinal slit 28 symmetrically to the horizontal center axis 25 and a straight boundary 29. The straight boundary 29 extends perpendicular to the center axis 25.

Further a hole 30 is shown in this drawing, the hole being oriented coaxial with the pivot axis 15. Every handle half 24 has the hole 30 at the same position.

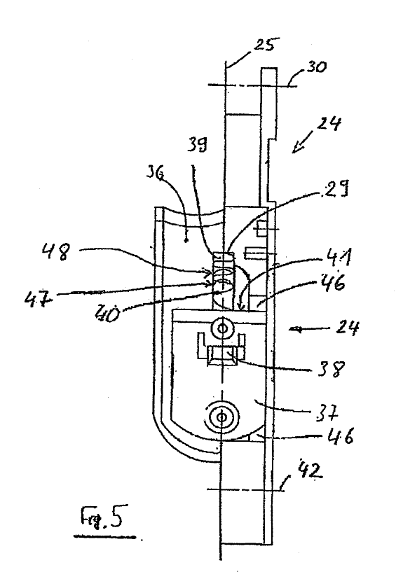

In FIG. 4, the handle 9 is shown in a simplified way from below, as it is assembled from two handle halves 24. It is the purpose of this figure to display the relations of the side faces to each other. An inner space 32 is enclosed by two side faces 33. The side faces 33 have an outer side 34 and an inner side 35 in each case.

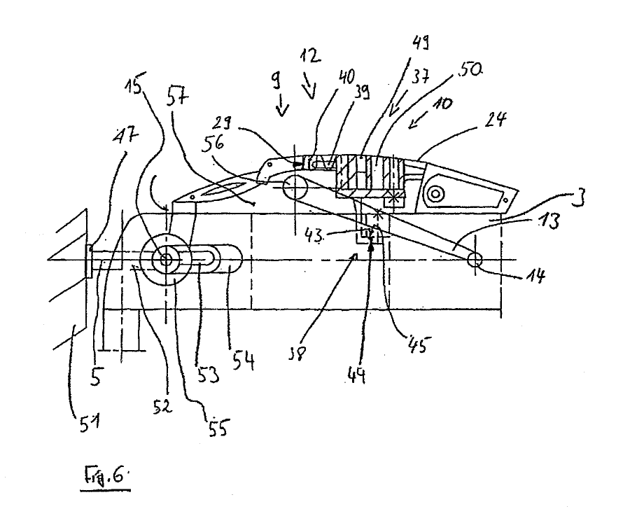

In FIG. 5, a cut through a plan view of the handle 9 is displayed. In the center of the drawing an inner side 36 of the locking slide 10 can be seen. In front of this, a support 37 can be seen. The support 37 is connected to the locking slide 10 in a positive manner by means of a plug connection.

The support 37 has a tenon 38 and a spring holder 39. A spring 40 is put over the spring holder 39. The spring 40 is positioned between a front edge 41 of the support 37 and the straight boundary 29.

The spring 40 pushes the support 37—as far as no further forces are acting—in the direction of a cross axis 42 which extends perpendicular to the center axis 25. Together with the support 37, also the tenon 38 is shifted in this direction. Thereby the tenon 38 is pressed under the protrusion 43, which is a component of the upper crossbar 3.

The support is movably supported on guide rails 46. Only one of the guide rails 46 is displayed. It has a rectangular shape.

In this situation, a tip 47 of the spring holder 39 has a first position 48. After shifting of the support 37 and thereby the spring holder 39 along the center axis 25 towards the cross axis 30, the tip 47 of the spring holder 39 has the position 48.

The locking slide 10 has now left the first end position. The handle 9 is pivotable about the pivot axis 15. The plastic buffer 17 is retracted from the frame by means of pivoting the handle 9. Now the door safety gate can be released from the frame.

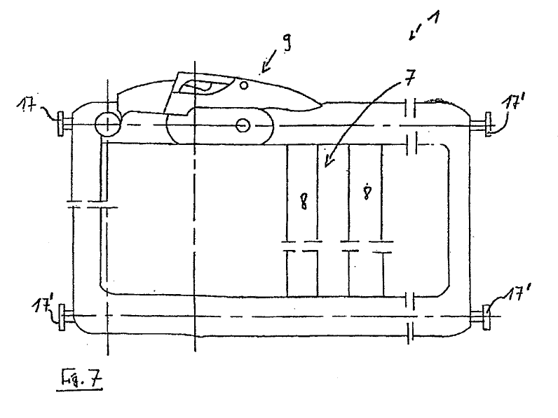

In FIG. 6, a locked handle 9 is displayed in a sectional view. The handle 9 rests upon the upper crossbar 3. The locking slide 10 is shown on the back 12 of the handle 9. It has the support 37, which is plugged on two sockets 49, 50. The sockets 49, 50 are integral part of the locking slide 10. They have a different height, respectively. The different heights of the sockets 49, 50 make sure that the support 37 can be plugged onto the sockets 49, 50 in just one orientation. The plugging of the support 37 onto the sockets 49, 50 is possible without the use of tools. Thereby the assembly time is accelerated.

The spring holder 39 is provided with the spring 40, which is designed as a coil spring. The spring 40 presses against the straight boundary 29 and hence generates the load with which the tenon 38 is pressed against the protrusion 43. Thereby, a bearing face 44 of the protrusion 38 is pressed against a holding face 45 of the protrusion 43. In this way, the handle 9 is secured in the first end position with the support of the locking slide 10.

In this position, the plastic buffer 17 is pressed against a frame 51. The handle 9 is locked. The door safety gate is firmly clamped into the frame 51. The plastic buffer 17 is located at one end of a screw 52 which is inserted into the upper crossbar 3 coaxially with the longitudinal axis 5 of the upper crossbar 3.

At its other end, the threaded rod 52 is screwed on a T-piece 53. The T-piece 53 is arranged in a slotted hole 54 and displaceable along the longitudinal axis 5. The pivot axis 15 extends perpendicular to the plane of the grid 2.

The handle 9 is pivotable about the pivot axis 15 in case the tenon 38 is no more embracing the protrusion 43. This situation comes to happen if the locking slide 10 is shifted against the mechanical resistance of the spring 40 in the direction of the straight boundary 29.

The eyes 55, together with the T-piece 53, form out a swivel bearing. Thereby the inner sides of the eyes 55 overlap the faces of the T-piece, which lie parallel to the plane 2. The swivel bearing allows for a pivoting of the handle 9 about the pivot axis 15.

By means of the pivoting of the handle 9 about the pivot axis 15 starting from the first end position, the T-piece 53 and the plastic buffer 17 are moved in the direction of the protrusion 43. By this movement, the plastic buffer 17 is retracted from its original position, in which it was pressing against the frame 51. The door safety gate is released.

The toggle mechanism 13 is supported in such way that it can be moved about a first axis 14 and a second axis 56. The first axis 14 extends perpendicular to the longitudinal axis 5 of the upper crossbar 3 and the plane 2. The second axis 56 extends perpendicular to the inner side 57 of the handle half 24. The front handle half is not shown.

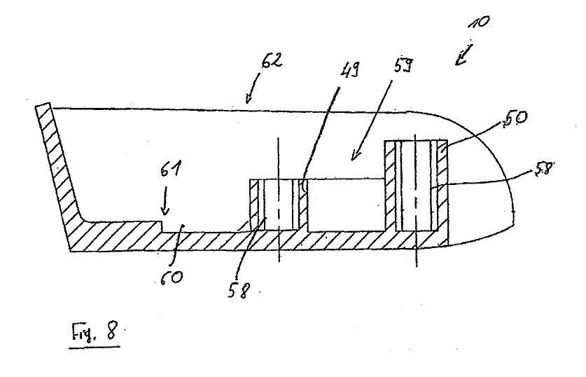

FIG. 7 shows a door safety gate 1 without the lath 19, the hinge 20 and the toggle mechanism 22. Only the displayed plastic buffer 17 can be moved by the movement of the handle 9. This embodiment has—compared to the embodiment described in FIG. 1—the advantage of a more cost-effective production. Only two of the lathes 8, which fill the grid face 7, are shown.

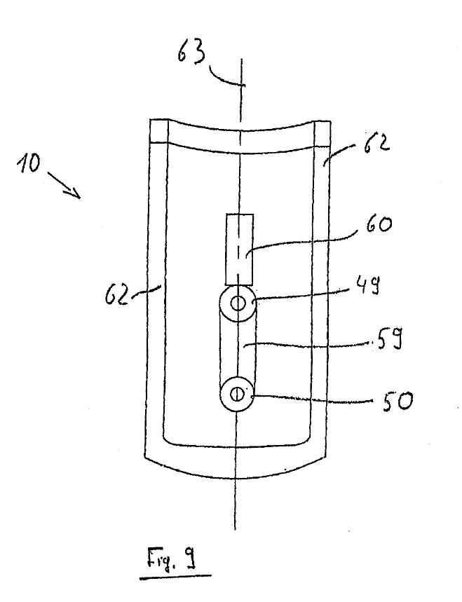

FIG. 8 shows a locking slide 10 as a cross section. The sockets 49, 50, which are integral components of the locking slide 10, can be particularly recognized. Both sockets 49, 50 have a female thread 58. The area between the socket 49 and the socket 50 has a web 59.

The support 37 is partially supported by the web 59. The thread 58 is needed in order to fixedly screw the support 37 on the locking slide 10.

A circular recess 60 is located to the left of the socket 49. Perpendicular to the plane of the figure, the recess 60 has a cross section in the shape of a circular arc. The recess 60 accommodates the spring holder 39 and the spring 40. Its left edge 61, after the assembly of the locking slide 10 into the handle 9, is directly below the straight boundary 29.

In this drawing, the locking slide 10 has a side guide 62 at its upper rim. By aid of the side guide 62, the locking slide 10 is movable on the guide 11 of the handle 9.

The locking slide 10 is made as a single piece.

FIG. 9 shows, inn a plan view, the components of the locking slide 10, which are arranged symmetrically to the center axis 63 of the locking slide 10.

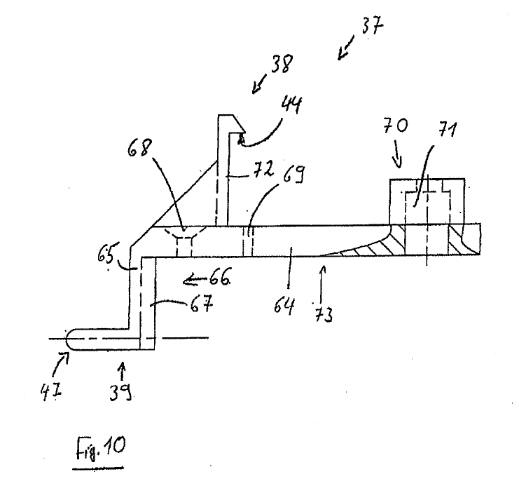

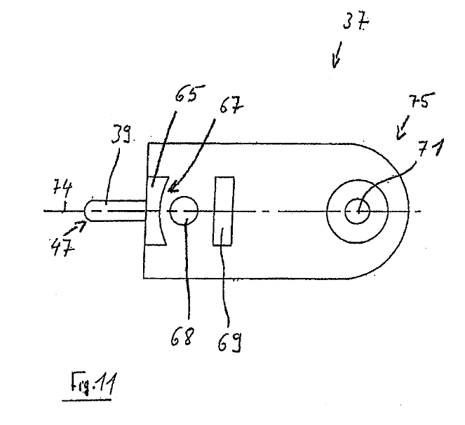

In FIG. 10, the support 37 is shown in a side view. The tenon 38 with the bearing face 44 and the spring holder 39 with the tip 47 can be particularly recognized.

The spring holder 39 is carried out parallel to a base 64. There is a distance holder 65 between the base 64 and the spring holder 39. It is located perpendicular to the base 64 and to the spring holder 39. Its inner side 66 has a circular arc-shaped recess 67. This circular arc-shaped recess 67 makes it possible to move the distance holder 65 directly in front of the socket 49 when the support 37 is moved onto the sockets 49, 50. The recess 67 extends over the entire height of the distance piece 65.

Apart from a lowered hole 68, the base 64 comprises a continuous slit 69. Furthermore, the base 64 has a cylindrical attachment 70 with a continuous hole 71. The holes 68 and 71 have the purpose to accommodate screws, the screws positively connecting the support 37 with the sockets 49, 50.

It is characteristic that the tenon 38 is integrated in a column 72. Its bearing face 44 is arranged parallel to the base 64.

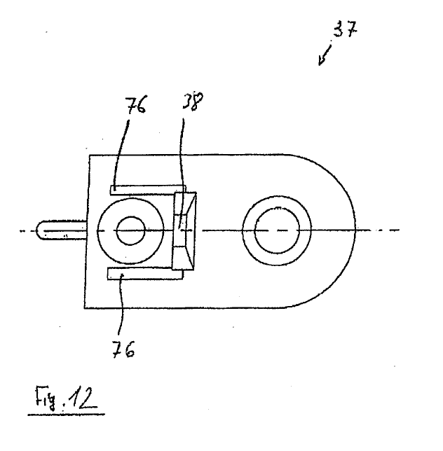

FIG. 11 shows a view from below under the support 37. Recognizable are the spring holder 39 with the tip 47 in the left region. To the right of this, on the base 64, is the distance piece 65 with the circular arc-shaped recess 67, the lowered hole 68, the slit 69 and the hole 71. Everything is arranged symmetrically with respect to the center axis 74. The base 64 has a rectangular shape which is terminated at its right end with a half circle 75.

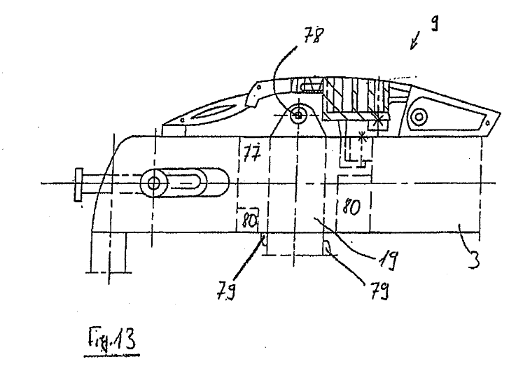

FIG. 12 shows a plan view on the support 37. Here, the tenon 38 as well as the supporting carriers 76 of the tenon 38, which stabilize its position, are essential.

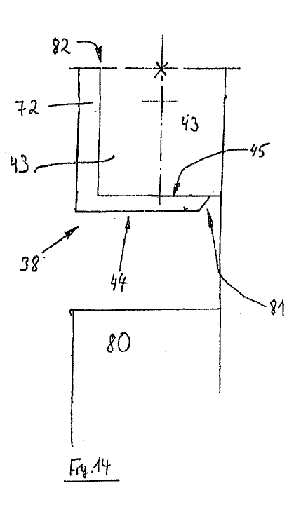

FIG. 13 shows a sectional view through the handle 9, which lies on the upper crossbar 3. There are two major differences compared to FIG. 5:

Firstly, the toggle mechanism is not shown in order to improve the overview. Secondly, the lath 19 from FIG. 1 is shown here. It reaches through the upper crossbar 3 within a pit 77.

The lath 19 is suspended on two cross tenons 78. the cross tenons 78, positioned opposite to each other respectively, are mounted on the inner faces of the handle halves 24. When assembling the two handle halves 24, the cross tenons 78 adjoin each other with their ends. Then they enclose lath 19, which before has been pushed over one of the tenons 78.

The lath 19 now has the task to transmit a movement of the handle 9 over the hinge 20 on the second toggle mechanism 22 and the plastic buffer 17, which is embedded in the lower crossbar 4.

A sideways guiding of the lath 19 in the pit 77 is achieved by the distance holder 79. Thereby, the lath 19 is guided in the pit 77, by means of border pieces 80, which are presently shown as covered.

Reference 81 points to a bevel which is provided at the tenon 38.

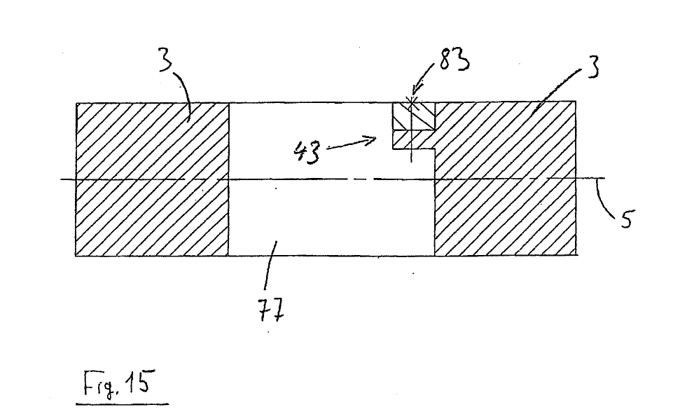

FIG. 14 shows, in an enlarged detail of FIG. 13, the position of the bevel 81. The bevel 81 is an integral component of the tenon 38. In the case of locking of the locking slide 10, the bevel 81 automatically moves against the spring 40. Thereby the bevel 81 is guided along an edge 82 of the protrusion 43, the edge extending parallel to the bearing face of the tenon 44.

FIG. 15 shows a partial sectional view of the upper crossbar 3. The protrusion 43 is placed in the pit 77. The protrusion 43 has two sections. The lower section is a component of the upper crossbar 3, The upper section is screwed upon the power section by means of a screw 83. This enables an easy exchange of the upper section, e.g. after damaging.

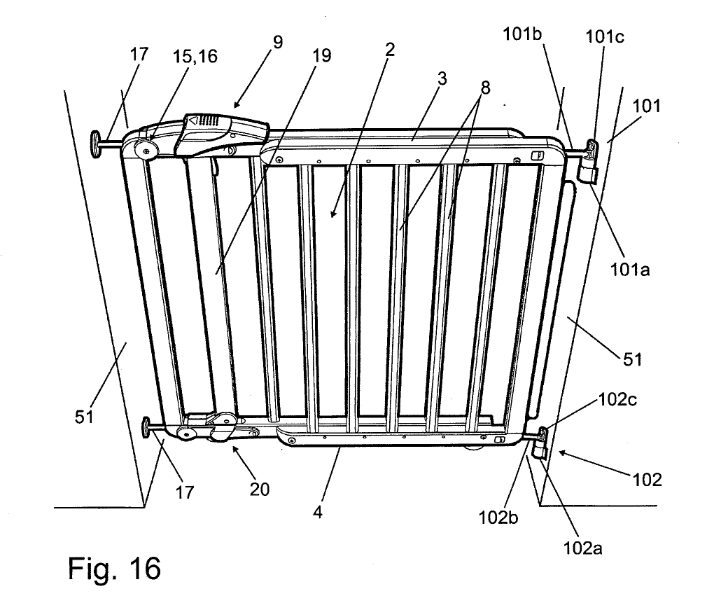

The embodiment shown in FIG. 16 is mostly the same as in FIG. 1. The design of the flat grid 2 with the handle 9, which can be fixed in an over-center-position with respect to the toggle mechanism 13, is identical. The door safety gate of FIG. 16, like the first embodiment, has a first and a second slide 17, which serve for the locking and which may be carried out as plastic buffers.

Other than in the first embodiment, the door safety gate has no rigid plastic buffers 17′ at the vertical side of the grid 2, which side being located opposite to the handle 9 and/or the slides 17, but therefore has an upper swivel 101 and a lower swivel 102. The swivels 101, 102 are screwed to the frame 51, presently door frame, by means of suitable swivel supports 101a, 102a, presently in the form of swivel bushes.

On the side of the door safety gate, rods 101b, 102b with threads on their ends (not shown) are screwed into front areas of the horizontal crossbars 3, 4. The rods 101b, 102b are carrying hinge pins 101c, 102c which extend into the swivel supports 101a, 102a. In this way, the entire door safety gate is held at the door frame 51 in a pivotable manner. The latch 9 and the therewith connected mechanism for the movement of the slides and plastic buffers 17 (see description of the first embodiment) primarily serve as a lock in order to prevent or allow for a pivoting of the door safety gate from the closed position.

In the drawing of FIG. 16, the slides 17 are pressing against the frame 51 in the locked position. It has to be understood that such pressing in the longitudinal direction of the slides 17 is not absolutely necessary in case support bushes are provided into which the slides 17 may protrude in a positively locked manner, but with slight play.

According to the demands, in one embodiment of FIG. 16 the door safety gate may further be entirely removable in an open position, for instance by simply taking the hinge pins out of the bushes. Such removal of the swivels 101, 102 may alternatively or optional be locked by suitable securing device.

It is to be understood that the pivotably articulated variant of the door safety gate of FIG. 16 may also be combined with a handle according to the second embodiment, i.e. with just one movable slide/plastic buffer 17.

In a particularly preferred embodiment, the rods 101b, 102b of the swivels 101, 102 are formed out such that the swivels can be mounted at the door safety gate alternatively or additionally to the rigid plastic buffer 17′, without basically changing the door safety gate. Thereby, two construction variants can be offered with just few different parts.

Generally, specific features of the different embodiments may plausibly be combined according to the respective demands.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A door safety gate comprising:
a handle having a locking slide and being secured against releasing in an end position of the locking slide, the handle being pivotable about a pivot axis and being drivingly connectable with a first slide or a plastic buffer;
an essentially flat first grid, the first grid having the handle arranged at an upper crossbar, a longitudinal axis of the first slide extending substantially parallel to a longitudinal axis of the upper crossbar, wherein the longitudinal axis of the upper crossbar lies in a plane of the door safety gate; and
a link mechanism having a lath and a second toggle mechanism,
wherein the handle is a part of a toggle mechanism, and
wherein the handle drives a second slide or a second plastic buffer, synchronously with the first slide through the link mechanism.

2. The door safety gate of claim 1, wherein the handle is U-shaped and partially surrounds the upper crossbar.

3. The door safety gate of claim 1, wherein the pivot axis extends substantially perpendicular to a plane of the door safety gate through the upper crossbar.

4. The door safety gate of claim 1, wherein the locking slide is preloaded in an end position.

5. The door safety gate of claim 1, wherein the locking slide is moveable in a longitudinal direction of the handle and substantially parallel to the longitudinal axis of the upper crossbar against the pivot axis, and wherein the handle is pivotable about the pivot axis.

6. The door safety gate of claim 1, wherein the locking slide has a web and two sockets on an inner side, wherein a support is plugged on the web and two sockets, and wherein the support has a tenon and a spring holder.

7. The door safety gate of claim 1, wherein the grid has a bottom crossbar, and the second slide is supported in the bottom crossbar substantially parallel to the first slide.

8. The door safety gate of claim 1, wherein the handle has an inner space, two side faces and a longitudinal slit arranged on a rear face.

9. The door safety gate of claim 1, wherein the handle is built from two pieces and is symmetrical, and wherein a parting is provided by a central axis of the rear face.

10. The door safety gate of claim 1, wherein the handle has two holes at one end, the holes opposing each other symmetrically and being located in a side face, in each case.

11. The door safety gate of claim 1, wherein the handle has guides at outer sides of its side faces.

12. The door safety gate of claim 1, wherein the handle has a stop on its rear face.

13. The door safety gate of claim 1, wherein the door safety gate is pivotally mounted to a frame via a hinge.
